(19) United States
(12) Patent Application Publication
(10) Pub. No.: US 2009/0037699 A1
(43) Pub. Date: Feb. 5, 2009

(54) APPARATUS AND METHOD FOR PROCESSING SEMICONDUCTOR

(75) Inventor: Takahito Matsuzawa, Tokyo (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/089,309

(22) PCT Filed: Oct. 13, 2006
(86) PCT No.: PCT/JP2006/320454

§ 371 Date: Apr. 4, 2008

(30) Foreign Application Priority Data
Oct. 14, 2005 (JP) 2005-300637

(51) Int. Cl. G06F 9/30

(52) U.S. Cl. 712/220; 712/E09.016

(57) ABSTRACT

A semiconductor processing apparatus includes a tester for inspecting a semiconductor device, a display unit 25, a control unit 21, an IC tag reader 29 and an auxiliary storage unit 23 for storing an authority allowed to each operator. The control unit 21 reads an ID from an IC tag possessed by an operator approaching the IC tag reader 29. The control unit 21 refers to the auxiliary storage unit 23 and determines the authority of the operator based on the read ID. Further, the control unit 21 allows an instruction to be inputted within the determined authority range, and composes a manipulation screen allowing a processing status to be viewed, and displays the manipulation screen on the display unit 25. When the operator moves away from the apparatus and the ID cannot be read any longer, the control unit 21 turns on a screen saver to hide the display.

### TECHNICAL FIELD

The present invention relates to a semiconductor processing apparatus and method for use in manufacturing or inspecting a semiconductor device.

### BACKGROUND ART

There is known a semiconductor processing apparatus for performing a film forming process on a semiconductor wafer (hereinafter, simply referred to as a wafer) or inspecting the wafer. In general, an appropriate control, an operation, a control and a maintenance by an operator and an appropriate maintenance by a manager are required to operate and maintain the semiconductor processing apparatus properly.

However, if a number of operators have access to the apparatus, the apparatus may be improperly set or confidential information stored therein may be leaked out.

In this regard, there has been a semiconductor manufacturing apparatus having a security function (authentication function). This semiconductor manufacturing apparatus can be manipulated by inputting IDs of the operators into the semiconductor processing apparatus. However, it is very troublesome to input the IDs every time, and a great burden is imposed on a worker who goes around while checking and controlling a number of apparatuses.

In view of the above-mentioned problem, Patent Reference 1 discloses a technique capable of solving the problem. Described in Patent Reference 1 is an apparatus additionally having an authentication function for automatically turning off or turning on a screen saver depending on whether an operator with an ID tag approaches the apparatus or moves away from it. The configuration disclosed in Patent Reference 1, however, has a drawback in that when a number of operators have an authority to manipulate the apparatus, same content is displayed to the different operators. Therefore, it is difficult to apply this technique to an authentication system of a semiconductor manufacturing apparatus which requires many operators to refer to and set information according to their respective roles.

Patent Reference 1: Japanese Patent Laid-open Application No. H11-95878

### DISCLOSURE OF THE INVENTION

### Problems to Be Solved by the Invention

In view of the foregoing, the present invention provides a semiconductor processing apparatus having an appropriate authentication system. Further, the present invention also provides a semiconductor processing apparatus which can be manipulated simply while a system security is maintained.

### Means for Solving the Problems

In order to accomplish the object, in accordance with one aspect of the present invention, there is provided a semiconductor processing apparatus including: a semiconductor processing unit for processing a semiconductor device; a display unit including a display screen for displaying an image; a display control unit for displaying, on the display unit, an instruction inputting screen for inputting an instruction for the semiconductor processing unit and/or a processing status display screen for displaying a processing status by the semiconductor processing unit; an identification information reading unit for reading identification information, which is stored in a storage device possessed by an operator, in a non-contact manner; and an authority storage unit for storing therein authority definition information defining an authority allowed to the operator, wherein the display control unit includes an authority determination unit for determining the authority allowed to the operator, which is specified by the identification information read by the identification information reading unit, based on the authority definition information stored in the authority storage unit; and a display restricting unit for generating and displaying, on the display unit, a manipulation screen, which enables the operator, within an authority range determined by the authority determination unit, to input the instruction for the semiconductor processing unit and/or to view the processing status by the semiconductor processing unit.

### BRIEF DESCRIPTION OF THE DRAWINGS

FIG. 1 provides a configuration view of a semiconductor processing system in accordance with an embodiment of the present invention;

FIG. 2 sets forth a configuration view of a tester shown in FIG. 1;

FIG. 3 presents a block diagram of a controller shown in FIG. 2;

FIG. 4 shows an example structure of an IC tag possessed by a worker (operator) in charge of operating or monitoring each semiconductor processing apparatus in the semiconductor processing system shown in FIG. 1;

FIG. 5A illustrates an example of security information stored in a manufacture management server of FIG. 1;

FIG. 5B illustrates an example of organization information stored in the manufacture management server of FIG. 1;

FIG. 6 offers a flowchart to describe a display control operation of the controller shown in FIG. 2;

FIG. 7A illustrates an example display screen of the tester shown in FIG. 2;

FIG. 7B illustrates an example display screen of the tester shown in FIG. 2; and

FIG. 7C illustrates an example display screen of the tester shown in FIG. 2.

### EXPLANATION OF CODES

101: Inspection apparatus
102: Film forming apparatus
103: Etcher
3: Roader unit
4: Prober unit
5: Inspection unit
6: Display device
9: Probe card
9A: Probe needle
10: Stage
11: Driving mechanism
12: Alignment mechanism
21: Control unit
22: Main storage unit
23: Auxiliary storage unit
24: Input unit
25: Display unit
26: Transmitting/receiving unit
27: Output unit
28: Time measuring unit
29: IC tag reader

### BEST MODE FOR CARRYING OUT THE INVENTION

Hereinafter, a semiconductor processing apparatus in accordance with an embodiment of the present invention will be described with reference to the accompanying drawings.

### FIRST EMBODIMENT

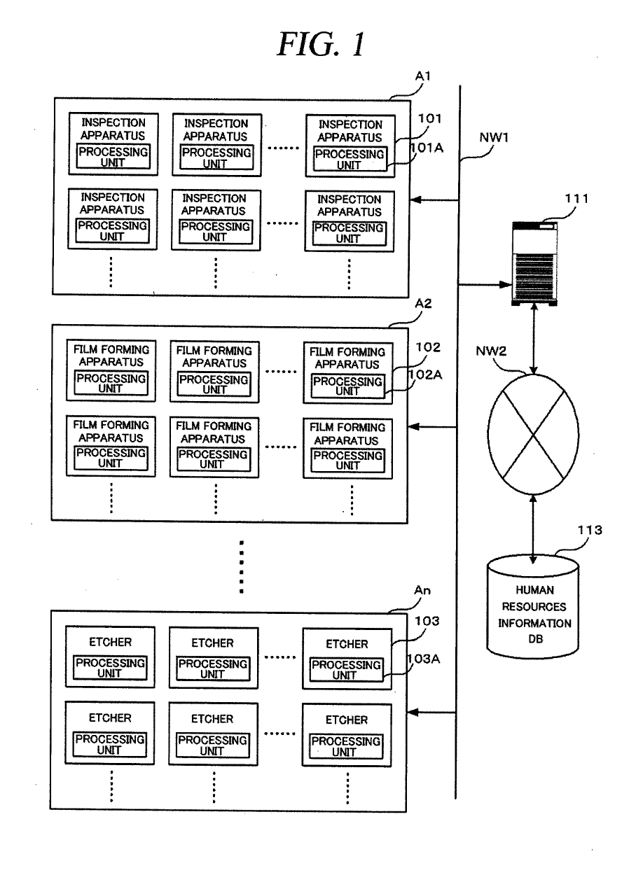

FIG. 1 shows a configuration of a semiconductor manufacturing apparatus system in accordance with an embodiment of the present invention.

As shown in FIG. 1, a plurality of semiconductor processing apparatuses are disposed in each of a multiplicity of areas A1 to An (n is an integer), and a number of persons in charge (operators) are stationed in each area. The persons in charge make the round of the areas under their responsibilities to operate and control the individual processing apparatuses.

Disposed in the area A1 are a number of inspection apparatuses (probers) 101 for inspecting final products of semiconductor devices (semiconductor chips), and disposed in the area A2 are a multiplicity of film forming apparatuses 102 such as CVD apparatuses. Further, a plurality of etchers (etching apparatuses) 103 are disposed in the area An.

Each of the semiconductor processing apparatuses 101 to 103 is connected to a manufacture management server 111 via a local area network (LAN) NW1.

The manufacture management server 111 is linked to a human resources information database 113 within a business management system server via an intra-company network NW2.

Here, a configuration of the semiconductor processing apparatuses 101 to 103 will be explained with reference to the inspection apparatus 101 for example.

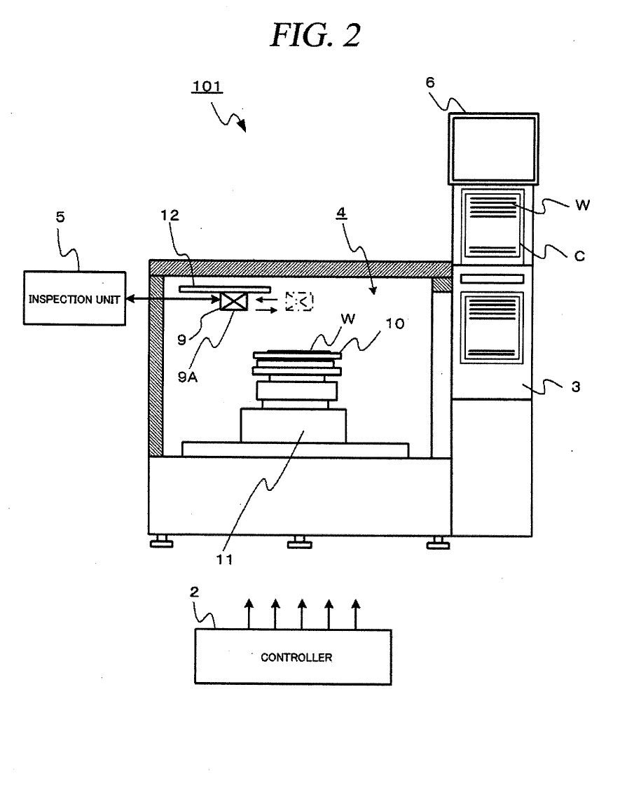

The inspection apparatus 101 is a so-called wafer inspection apparatus having an inspection unit (processing unit) 101A for performing an inspection of a wafer. As shown in FIG. 2, the inspection apparatus 101 includes a controller 2, a loader unit 3, a prober unit 4, an inspection unit 5 and a display device 6.

The loader unit 3 takes out a wafer W not inspected yet from a cassette C accommodating wafers W therein, and conveys it onto a stage 10 inside the prober unit 4. After a test of the wafer W is completed, the loader unit 3 picks up the wafer W from the stage 10 and transfers the wafer W back into the cassette C to accommodate the wafer W therein again.

The prober unit 4 includes the stage 10 for attracting and holding the wafer W thereon; a driving mechanism 11 for moving the stage 10; a probe card 9; and an alignment mechanism 12. The stage 10 has therein a chuck for attracting the wafer W and a heater for heating the wafer W. The driving mechanism 11 serves to move the stage 10 along X, Y, Z and a directions, wherein the X and Y directions refer to two perpendicular directions on a horizontal plane; the Z direction refers to a vertical direction; and the e direction indicates a rotational direction on the horizontal plane. The probe card 9 includes probes (probe needles) 9A each serving to transmit a test signal. The alignment mechanism 12 aligns the probes 9A with respect to the wafer W on the stage 10 by moving the probe card 9.

The inspection of semiconductor devices by the inspection unit 5 is carried out by inputting various test signals from the probes 9A to the semiconductor devices formed on the wafer W placed on the stage 10 according to test patterns which are set in advance depending on the semiconductor devices (product type) to be tested; and then by checking the outputs.

The display device 6 constitutes a touch panel type display device by being arranged on a touch panel type input device. The display device 6 serves to provide various data to an operator, while also functioning as an operation panel.

The controller 2 controls the entire operation of the inspection apparatus 101. By controlling the loader unit 3, the controller 2 allows a wafer W not inspected yet to be taken out of the cassette C and placed on the stage 10. Further, by controlling the loader unit 3, the controller 2 makes the inspected wafer W lifted up from the stage 10 and set in the cassette C again.

Further, the controller 2 also drives the driving mechanism 11 to move the stage 10 carrying thereon the wafer W to be inspected in x, y, z and θ directions. In addition, the controller 2 drives the alignment mechanism 12 to move the probe card 9 such that the probes 9A are aligned to and brought into contact with the wafer W.

Moreover, the controller 2 controls the heater embedded in the stage 10 to thereby heat the wafer W to be inspected.

Furthermore, the controller 2 sends information specifying a semiconductor device to be inspected to the inspection unit 5. Further, by designating a test pattern, the controller 2 enables the inspection of the semiconductor device, and receives an inspection result.

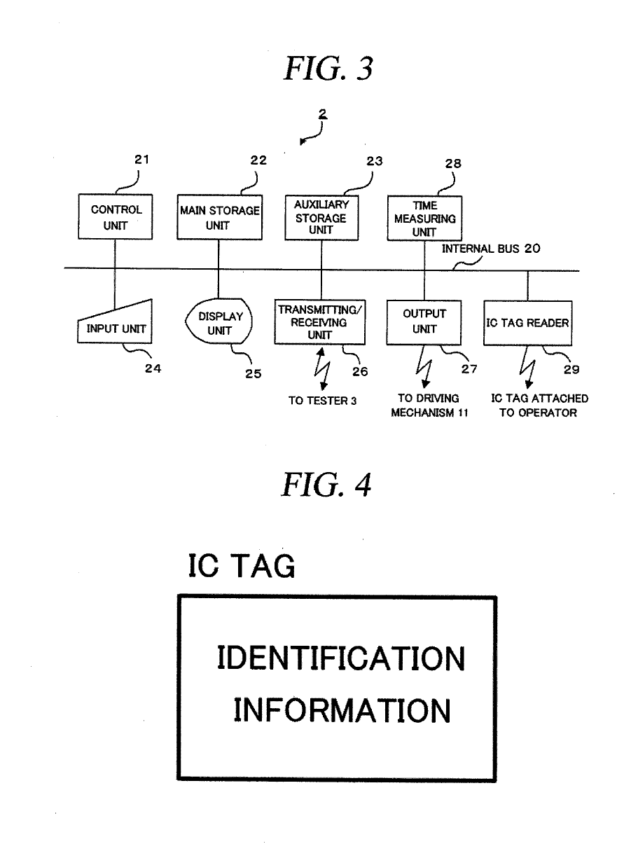

FIG. 3 is a block diagram showing a configuration of the controller 2. The controller 2 includes a control unit 21, a main storage unit 22, an auxiliary storage unit 23, an input unit 24, a display unit 25, a transmitting/receiving unit 26, an output unit 27, a time measuring unit 28 and an IC tag reader 29, as shown in FIG. 3. The main storage unit 22, the auxiliary storage unit 23, the input unit 24, the display unit 25, the transmitting/receiving unit 26, the output unit 27, the time measuring unit 28 and the IC tag reader 29 are all connected to the control unit 21 via an internal bus 20.

The control unit 21 includes a CPU (Central Processing Unit) and the like, and monitors the entire operational status of the inspection apparatus 2 according to programs stored in the auxiliary storage unit 23. As described, the control unit 21 controls the loader unit 3, the prober unit 4 and the inspection unit 5; executes a process according to an input from the input unit 24; and, as the process result, displays inputted information, a control state of a driving unit or the like on the display unit 25.

Further, the control unit 21 automatically detects an approach of an operator who is making the round of a certain area and determines an authority of that operator, as will be described later, thus enabling the operator to manipulate or read information within the authority range.

The main storage unit 22 includes a RAM (Random-Access Memory) or the like and is used as a working area of the control unit 21.

The auxiliary storage unit 23 includes a nonvolatile memory such as a flash memory, a hard disk, a DVD (Digital Versatile Disc), a DVD-RAM (Digital Versatile Disc Random-Access Memory), a DVD-RW (Digital Versatile Disc Rewritable), and the like, and stores therein a program required to allow the desired process to be carried out by the control unit 21 in advance. Further, in response to an instruction from the control unit 21, the auxiliary storage unit 23 supplies data used in this program or other programs to the control unit 21, and stores therein data supplied from the control unit 21.

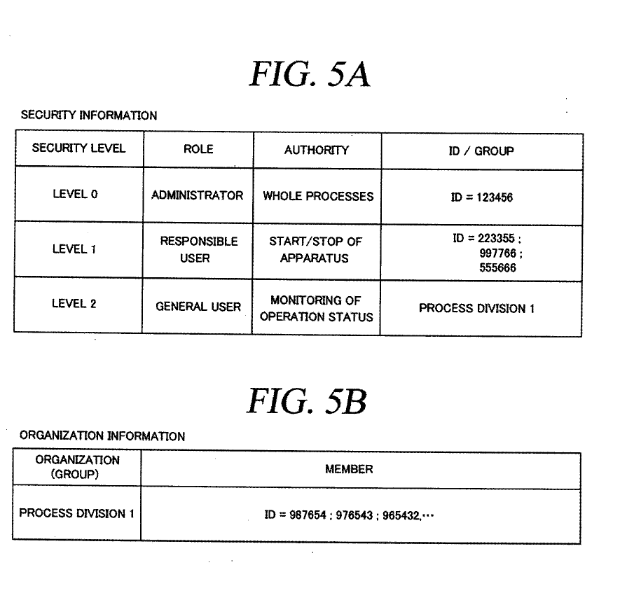

The auxiliary storage unit 23 stores therein information upon security levels or information upon an organization capable of operating the semiconductor processing apparatus and upon IDs of members of the organization, as will be described later with reference to FIGS. 5A and 5B.

The input unit 24 includes a touch panel arranged on a display screen of the display device 6 of FIG. 2. The input unit 24 may further include auxiliary components, for example, a keyboard or a key switch, and a pointing device such as a mouse or a joystick, and so forth.

The display unit 25 constitutes the display device 6 of FIG. 2 and includes a CRT (Cathode Ray Tube), a LCD (Liquid Crystal Display), or the like. The display unit 25 displays parameters inputted by the input unit 24 to control the driving mechanism 11 or displays the control state of the driving mechanism 11, for example, current position coordinates of the stage, and so forth.

The transmitting/receiving unit 26 includes a LAN (Local Area Network) interface or a serial interface connected to a modem, a network termination (NT) device, or the like. The control unit 21 transmits required information to the inspection unit 5 (see FIG. 2) and receives inspection information from the inspection unit 5 via the transmitting/receiving unit 26. For example, the control unit 21 transmits, to the inspection unit 5, information notifying that the inspection is ready to start and receives, from the inspection unit 5, the inspection result or information notifying a termination of the inspection.

The output unit 27 includes a serial interface or a parallel interface. The output unit 27 outputs control instruction values to the loader unit 3, the driving mechanism 11, the alignment mechanism 12 and so forth according to commands of the control unit 21.

The time measuring unit 28 includes, for example, a crystal oscillator, a counter for counting clock pulses generated from the crystal oscillator, and a clock. The time measuring unit 28 also functions as a timer for any time interval according to a command of the control unit 21. For example, the control unit 21 may function as a display duration timer, which will be described later.

The IC tag reader 29 reads an ID (identification information) recorded in the IC tag in a non-contact manner. Each operator who goes around the areas A1 to An has a non-contact type IC tag. As shown in FIG. 4, recorded on each IC tag is a personal ID of the operator who possesses that IC tag. The IC tag reader 29 identifies the approaching operator by reading the ID. Further, the IC tag reader 29 can also determine the authority assigned to the operator.

Furthermore, each of the other semiconductor processing apparatuses, i.e., the film forming apparatuses 102, the etchers 103 or the like, has a processing unit 102A or 103A for performing a film forming process such as a CVD process or an etching process. Further, each of them also has a controller having the same IC tag reader as that of the controller 2 shown in FIG. 3.

The manufacture management server 111 connected to the areas A1 to An via the local area network (NW1) stores therein security information and organization information as shown in FIGS. 5A and 5B.

The security information is data indicating which types of operations are possible for each security level and who has that security level, for each of the semiconductor processing apparatuses 101 to 103.

For example, FIG. 5A illustrates an example of security information for the inspection apparatus 101. As shown therein, an operator of security level 0 has a full authority to manage the inspection apparatus 101, for example, to modify and newly register various parameters or recipes. Meanwhile, an operator of security level 1 is authorized to select preset parameters to start or stop a process, though the operator cannot modify and newly register control parameters or recipes. Meanwhile, a general manufacturing engineer of security level 2 is allowed to perform only a limited manipulation of, for example, monitoring an operational status of the inspection apparatus during the inspection process, monitoring the inspection result, stopping the inspection apparatus in an emergency, and so forth.

Further, the security information also specifies that the security level 0 is assigned to an operator whose ID is 123456; the security level 1 is assigned to three operators whose IDs are 223355, 997766 and 555666, respectively; and the security level 2 is assigned to members of Process Division 1.

Moreover, as shown in FIG. 5B, registered in an organization information file are IDs assigned to members belonging to each organization (group). Such security information or organization information as shown in FIGS. 5A and 5B also exists in each of the other semiconductor processing apparatuses including the film forming apparatuses 102 and the etchers 103.

Now, an operation of the semiconductor processing apparatus having the above-configuration will be explained with reference to the inspection apparatus 101 for example. First, as a premise, the manufacture management server 111 is supposed to access the human resources information DB 113 at night time, for example, and reads up-to-date data on members of divisions relevant to the operation and manipulation of the semiconductor processing apparatuses 101 to 103. For example, the manufacture management server 111 reads the IDs of the members of Process Division 1 at that time, and generates modification information indicating the content of human resources information changed from that of the previous time.

Further, after the manufacture management server 111 reads the up-to-date human resources information, each of the semiconductor processing apparatuses 101 to 103 accesses the manufacture management server 111. Then, each of the semiconductor processing apparatuses 101 to 103 reads and updates the modification information of the organization information relevant to oneself, thus keeping the latest copy of the organization information in its auxiliary storage unit 23. For example, the inspection apparatus 101 reads IDs of members (modification information) belonging to a certain group (Process Division 1) set in its security information, and keeps the copy of that information in the auxiliary storage unit 23.

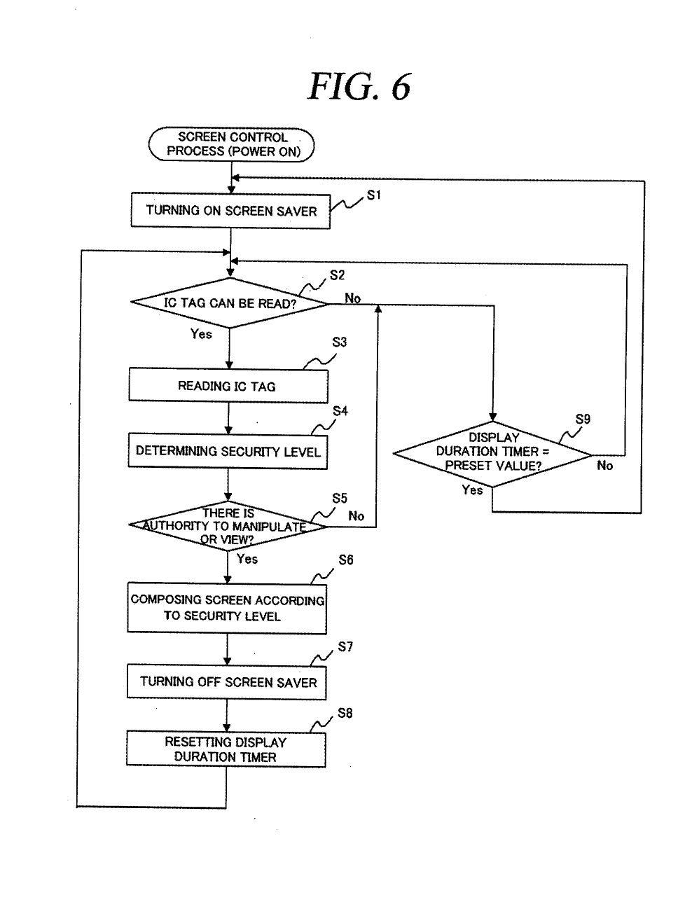

Subsequently, if the inspection apparatus 101 is powered on, the control unit 21 of the controller 2 starts other general control operations, while also initiating a screen control process described in FIG. 6. Since the general inspection operations are identical with those known in the relevant art, the following description will be provided focusing on an inventive screen control operation of the inspection apparatus 101 in accordance with the embodiment of the present invention.

First, the control unit 21 of the controller 2 displays a screen saver on the display unit 25 to conceal information shown on the display unit 25 (step S1).

Subsequently, the control unit 21 determines whether an IC tag exists nearby and an ID can be read or not via the IC tag reader 29 (step S2).

If it is determined that the IC tag exists nearby and the ID can be read (that is, that there is an operator nearby) (Yes in step S2), the control unit 21 reads the ID from the IC tag (step S3). The control unit 21 determines a security level assigned to the operator from the read ID by referring to the security information and the organization information stored in the auxiliary storage unit 23 (step S4).

For example, in the event that the retrieved ID is directly registered in the security information, a security level of it is specified. On the other hand, when the retrieved ID is not registered in the security information, it is then determined whether an organization to which the ID belongs is registered or not. If that organization (group) is registered, the control unit 21 specifies a security level corresponding to that organization (group). Moreover, if the read ID corresponds to more than one security levels, the control unit 21 specifies the highest security level. Further, when plural IDs are read, the control unit 21 specifies the highest security level among security levels corresponding to the plural IDs, for example.

Thereafter, the control unit 21 determines based on the determined security level whether the operator having the read ID has an authority to manipulate or monitor the inspection apparatus 101 (step S5). That is, if the read ID corresponds to one of the security levels 0 to 2 (Yes in step S5), it is determined that the operator has an authority to manipulate or monitor the apparatus 101, so that the process proceeds to a step S6.

Meanwhile, if the read ID does not correspond to any of the security levels 0 to 2 (No in the step S5), it is determined that the operator does not have the authority to manipulate or monitor the apparatus 101, so that the process proceeds to a step S9.

In the step S6, the control unit 21 generates a process selecting screen according to the security level of the operator. Then, the control unit 21 turns off the screen saver (step S7) and displays the screen generated in the step S6.

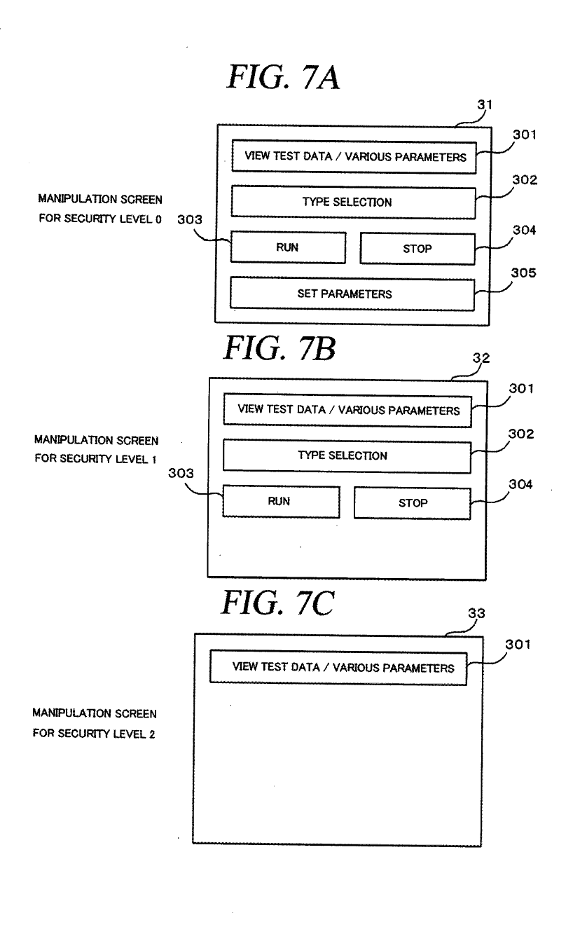

In the step S6, the control unit 21 changes the generated screen according to, for example, the security level determined in the step S5, as illustrated in FIGS. 7A to 7C.

First, if the read ID is found to correspond to the security level 0, a manipulation screen allowing a full range of manipulation, for example, a manipulation screen 31 shown in FIG. 7A, is generated. This manipulation screen 31 includes a selecting button 301 for viewing (displaying) various parameters and measurement data; a type selecting button 302 for selecting a product type of an inspection target; a run button 303 for operating the inspection apparatus 101; a stop button 304 for stopping the inspection apparatus 101; and a parameter setting button 305 for setting the various parameters. For example, in case that an inspection of a new semiconductor device is started, an operator of the security level 0 (ID=123456) approaches the display device 6 of the inspection apparatus 101. Then, the operator manipulates the parameter setting button 305 on the screen as shown in FIG. 7A and opens a screen for setting parameters. Afterwards, through a general operation, the semiconductor device (product type) of the inspection target is matched with a test pattern, and this information is stored in the auxiliary storage unit 23 or the like.

Meanwhile, if the read ID is determined to correspond to the security level 1, the control unit 21 generates a manipulation screen for allowing manipulation and monitoring of the apparatus within an authority range permitted to the operator of the security level 1. For example, as shown in FIG. 7B, a manipulation screen 32 is generated wherein it includes the selecting button 301 for viewing (displaying) the various parameters and measurement data; the type selecting button 302 for selecting the product type of the inspection target; the run button 303 for operating the inspection apparatus 101; and the stop button 304 for stopping the inspection apparatus 101. This manipulation screen 32 does not have the parameter setting button 305. Therefore, it is impossible for the operator of this security level to open the screen for setting parameters by pressing the parameter setting button 305 to set various parameters.

For example, when the inspection apparatus 101 is powered on to start an inspection, the operator of the security level 0 or 1 (ID=123456, 223355, 997766 or 555666) approaches the inspection apparatus 101. Then, from a screen displayed by the control unit 21 as shown in Fig. FIG. 7A or 7B, the operator specifies a product type of a semiconductor device to be inspected by manipulating the type selecting button 302. As a result, the control unit 21 notifies the inspection unit 5 of the product type of the semiconductor device or a test pattern. Subsequently, in order to start the inspection, the operator presses the run button 303. As the run button 303 is pressed, the control unit 21 controls the loader unit 3, the prober unit 4 and the inspection unit 5 so that the inspection process of the semiconductor device is carried out.

Further, to stop the inspecting operation, the stop button 304 should be pressed. As the stop button 304 is pressed, the control unit 21 controls the loader unit 3, the prober unit 4 and the inspection unit 5 so that the inspection process of the semiconductor device is stopped.

Furthermore, if it is determined that the ID read in the step S3 corresponds to the security level 2, the control unit 21 generates a manipulation screen for allowing manipulation and monitoring of the apparatus within an authority range permitted to the operator of the security level 2. For example, a manipulation screen 33 having the selecting button 301 for viewing (displaying) the various parameters and measurement data, as illustrated in FIG. 7C, is generated. The manipulation screen 33 does not have the inspection target selecting button 302, the run button 303, the stop button 304 and the parameter setting button 305. Accordingly, it is impossible for the operator of this security level to select the kind or type of the semiconductor device to be inspected by opening a selecting screen for selecting an inspection target through the type selecting button 302; to start the inspecting operation through the run button 303; to stop the inspecting operation through the stop button 304; or to set various parameters by opening the screen for setting parameters through the parameter setting button 305.

For example, to view or check a progress, an inspection result, an inspection status or the like of the inspection in operation, the operator having any of the security levels 0 to 2 approaches the inspection apparatus 101, and manipulates the viewing button 301 from any one of the screens 31 to 33 illustrated in FIGS. 7A to 7C, to thereby render the parameters and so forth displayed.

Thereafter, the control unit 21 resets the display duration timer provided on the time measuring unit 28 (step S8), whereby the process returns back to the step S2.

Meanwhile, if it is determined in the step S2 that no IC tag can be read (that is, no ID can be detected) (No in the step S2) or if it is determined in the step S5 that the operator does not have the authority to manipulate or view the apparatus (No in the step S5), it is then decided whether the display duration timer provided on the time measuring unit 28 has reached a preset value (step S9). Here, if the display duration timer has reached the preset value, it implies that, after the screen saver was turned off in the step S7 to display the screen corresponding to a security level, a preset period of time has elapsed after the operator ID cannot be read any longer. Here, if the display duration timer has reached the preset value (Yes in the step S9), the process returns back to the step S1 and the screen saver is turned on to hide the display. Meanwhile, if the display duration timer has not reached the preset value (No in the step S9), the process returns back to the step S2.

With the above-described configuration, the screen saver is usually kept turned on so that the displayed information of each of the semiconductor processing apparatuses 101 to 103 is protected. Meanwhile, when an operator having an authority to manipulate or monitor the apparatus approaches the apparatus, the screen saver is turned off, and a screen for allowing only a manipulation within an authority range of that operator is automatically displayed. Accordingly, the operator can perform an authentication easily without inputting identification information, and thus can manipulate or monitor the apparatus. Moreover, the display control is carried out such that the operator can access only to information within the allowed authority range defined by the read identification information. Therefore, an unauthorized manipulation or a leakage of information can be prevented.

Here, it is to be noted that the present invention is not limited to the embodiment described above, but can be modified or applied in various ways. For example, in the flowchart of FIG. 6, the manipulation screen according to the detected security level is generated when the ID information of the IC tag is read and the operator having the ID is determined to have the authority to manipulate or monitor the semiconductor processing apparatus (Yes in the step S5). In the event that a determined security level is equal to a security level corresponding to a manipulation screen displayed immediately prior to the current one, the previous screen may be kept displayed (that is, the screen saver is turned off and the previous screen may be displayed).

Moreover, in the above-described embodiment, though the information registered in the human resources information file is used as the organization information, it may be also possible to use other information instead.

Further, though the security information and the organization information are used together, it may be also possible to register only the ID information in the security information without adding the organization (group) information. That is, it may be possible not to use the organization information. In addition, the flowchart described in FIG. 6 or the screens illustrated in FIGS. 7A to 7C are nothing more than examples, and can be modified as required. Besides, the above-described hardware configurations or flowcharts are examples and they can be varied or modified as required.

Furthermore, in the above-described embodiment, though the present invention has been explained with reference to the inspection apparatus, the present invention can be widely applied to various types of apparatuses for processing semiconductor devices (for example, for treating a semiconductor wafer itself, performing a film formation on a semiconductor wafer, performing a film treatment (patterning or the like) to inspect or check, and the like).

In the above embodiment, it has been illustrated that an operation program of each semiconductor processing apparatus is stored in the auxiliary storage unit in advance. However, it may be also possible to store the program for executing the above-descried processing operations in a disk device of a certain server device on a communication network such as the Internet and to download the program into each semiconductor processing apparatus, for example, by embedding the program in a carrier wave. Further, the aforementioned processes can be carried out by starting and operating the program while the program is being transmitted via the communication network.

Moreover, this application claims the benefit of Japanese Patent Application No. 2005-300637, filed on Oct. 14, 2005, the disclosure of which is incorporated herein by reference.

### INDUSTRIAL APPLICABILITY

The present invention can be applied to a semiconductor processing apparatus, and the apparatus in accordance with the present invention can carry out an authentication process easily without inputting ID information thereto. Further, since the display control is performed such that an operator is allowed to access information within an authority range assigned to the operator, an unauthorized manipulation or a leakage of information can be prevented.

1. A semiconductor processing apparatus comprising:
a semiconductor processing unit;
a display unit including a display screen for displaying an image;
a display control unit for displaying, on the display unit, an instruction inputting screen for inputting an instruction for the semiconductor processing unit and/or a processing status display screen for displaying a processing status by the semiconductor processing unit;
an identification information reading unit for reading identification information, which is stored in a storage device possessed by an operator, in a non-contact manner; and
an authority storage unit for storing therein authority definition information defining an authority allowed to the operator,
wherein the display control unit includes an authority determination unit for determining the authority allowed to the operator, which is specified by the identification information read by the identification information reading unit, based on the authority definition information stored in the authority storage unit; and a display restricting unit for generating and displaying, on the display unit, a manipulation screen, which enables the operator, within an authority range determined by the authority determination unit, to input the instruction for the semiconductor processing unit and/or to view the processing status by the semiconductor processing unit.

2. The semiconductor processing apparatus of claim 1, wherein the display control unit includes:
a screen saver display control unit for displaying a screen saver for concealing the manipulation screen; and
a screen saver canceling control unit for turning off the screen saver when the authority determination unit determines that the operator has the authority.

3. The semiconductor processing apparatus of claim 1, wherein the identification information reading unit includes an IC tag reader for reading the identification information stored on a non-contact type IC tag possessed by the operator.

4. The semiconductor processing apparatus of claim 1, wherein the semiconductor processing unit includes at least one of a processing unit for processing a base body and an inspecting unit for inspecting the base body processed by the processing unit.

5. The semiconductor processing apparatus of claim 1, wherein the authority storage unit includes:
a group authority storage unit for storing therein an authority for each group; and
a member information storage unit for storing therein member information indicating to which group each operator belongs.

6. The semiconductor processing apparatus of claim 5, further comprising:
a modification detecting unit for detecting a change in a human resources information file by referring to the human resources information file and generating modification information specifying the detected change; and
a member information updating unit for updating the member information stored in the member information storage unit based on the modification information generated by the modification detecting unit.

7. A method for displaying a processing status, comprising:
processing a semiconductor;
displaying a screen;
controlling a display in the displaying step by displaying an instruction inputting screen for inputting an instruction for the semiconductor processing step and/or a processing status display screen for displaying a processing status by the semiconductor processing step;
reading identification information, which is stored in a storage device possessed by an operator, in a non-contact manner;
storing authority definition information defining an authority allowed to the operator;
determining the authority allowed to the operator, which is specified by the identification information read in the identification information reading step, based on the authority definition information stored in the authority storing step; and
restricting the display in the displaying step by generating and displaying a manipulation screen, which enables the operator, within an authority range determined by the authority determination step, to input the instruction in the semiconductor processing step and/or to view the processing status in the semiconductor processing step.

8. The method of claim 7, wherein the display control step includes:
displaying a screen saver for concealing the manipulation screen; and
turning off the screen saver when it is determined in the authority determination step that the operator has the authority.

9. The method of claim 7, wherein in the identification information reading step, the identification information stored on a non-contact type IC tag possessed by the operator is read.

10. The method of claim 7, wherein the semiconductor processing step includes at least one of:
processing a base body; and
inspecting the base body processed in the processing step.

11. The method of claim 7, wherein the authority storing step includes:
storing an authority for each group; and
storing member information indicating to which group each operator belongs.

12. A semiconductor processing apparatus comprising:
a semiconductor processing means;
a display means including a display screen for displaying an image;
a display control means for displaying, on the display means, an instruction inputting screen for inputting an instruction for the semiconductor processing means and/or a processing status display screen for displaying a processing status by the semiconductor processing means;
an identification information reading means for reading identification information, which is stored in a storage device possessed by an operator, in a non-contact manner; and
an authority storage means for storing therein authority definition information defining an authority allowed to the operator,
wherein the display control means includes an authority determination means for determining the authority allowed to the operator, which is specified by the identification information read by the identification information reading means, based on the authority definition information stored in the authority storage means; and a display restricting means for generating and displaying, on the display means, a manipulation screen, which enables the operator, within an authority range determined by the authority determination means, to input the instruction for the semiconductor processing means and/or to view the processing status by the semiconductor processing means.
